(19) United States
(12) Patent Application Publication
(10) Pub. No.: US 2025/0181407 A1
(43) Pub. Date: Jun. 5, 2025

(54) QUOTALESS NAMESPACE RESOURCE MANAGEMENT SYSTEM AND METHOD FOR HYPER-PARAMETER OPTIMIZATION IN KUBERNETES ENVIRONMENTS

(71) Applicant: DataStreams Corp., Seoul (KR)

(72) Inventors: Dong-Wook LEE, Seoul (KR); Gyu-Hong CHOI, Seoul (KR); Hana KIM, Seoul (KR); Seung-Tae CHUN, Seoul (KR)

(21) Appl. No.: 18/538,794

(22) Filed: Dec. 13, 2023

(30) Foreign Application Priority Data
Nov. 30, 2023 (KR) 10-2023-0171607

(51) Int. Cl. G06F 9/50; G06F 18/23211

(52) U.S. Cl. CPC G06F 9/5033; G06F 18/23211

(57) ABSTRACT

Disclosed is a quota-less namespace resource management method and system for hyperparameter optimization in a Kubernetes environment. A resource management method performed by a resource management system may include performing resource management for searching for a hyperparameter combination of a machine learning model that achieves a target performance of the machine learning model in an available resource amount of Kubernetes; and searching for the hyperparameter combination of the machine learning model that achieves the target performance of the machine learning model according to the performed resource management.

### CROSS-REFERENCE TO RELATED APPLICATION(S)

This application claims the priority benefit of Korean Patent Application No. 10-2023-0171607, filed on Nov. 30, 2023, in the Korean Intellectual Property Office, the disclosure of which is incorporated herein by reference.

### BACKGROUND

### 1. Field of the Invention

The following description relates to resource management technology. This work was supported by the Technology development Program (RS-2022-00140586) funded by the Ministry of SMEs and Startups (MSS, Korea).

### 2. Description of the Related Art

With the advent of the area in which artificial intelligence/machine learning (AI/ML) technology influences the overall industry, the use of an AI/ML model is gradually becoming an essential element in the software (SW) development process. In this environment, the importance and need of machine learning operations (MLOps) that generate the AI/ML model, optimize the performance thereof and use the same continues to increase. Major cloud companies, such as Amazon, Google, and MS, and many startup companies are providing commercial software solutions for MLOps and opensource software, such as Kubeflow and MLflow, also provides MLOps functions.

When performing MLOps, a process for optimizing the performance of a model includes a hyperparameter optimization (HPO). The AI/ML model performs tens to hundreds of experiments while changing a value (hyperparameter) that affects model learning to achieve desired performance in a model learning process. In an initial stage, AI/ML model developers used a lot of time by sequentially performing this process and research for automating this process was conducted to improve the above issue. In particular, in a Kubernetes environment, it was possible to dramatically improve the efficiency of hyperparameter optimization (HPO) by containerizing each experiment and by simultaneously performing the same in parallel.

In Kubernetes, an experiment performed with a single hyperparameter set is executed as a pod that is a Kubernetes resource and the pod is allocated with a resource (central processing unit (CPU) and memory) for execution. In an ideal situation in which resources are infinite, it may be good to provide a sufficient amount of resources to each pod and to quickly complete an experiment. However, even for companies, such as major clouds, it is not easy to achieve the same and, particularly, there is a need to efficiently allocate a limited amount of resources to a pod in an on-premise Kubernetes configured with limited hosts.

Also, when performing hyperparameter optimization (HPO), it is possible to reduce an amount of time used to find a target value by simultaneously conducting a plurality of experiments with hyperparameter sets having different values. Kubernetes achieves this by running the same experimental container as a pod with different hyperparameters. The efficiency of HPO may vary depending on the number of pods that are simultaneously generated (parallelism). Even in this case, the number of pods simultaneously running is affected by limited Kubernetes cluster resources.

### SUMMARY

Example embodiments are to maximize the efficiency of hyperparameter optimization (HPO) by securing resources for performing hyperparameter optimization when performing multiple hyperparameter optimization in a Kubernetes environment, by distributing resources between the multiple hyperparameter optimization, and by allocating optimized resources to each pod within the secured resources and, at the same time, optimizing the number of experiment pods that are simultaneously running.

According to an aspect, there is provided a resource management method performed by a resource management system, the resource management method including performing resource management for searching for a hyperparameter combination of a machine learning model that achieves a target performance of the machine learning model in an available resource amount of Kubernetes; and searching for the hyperparameter combination of the machine learning model that achieves the target performance of the machine learning model according to the performed resource management. The performing of the resource management includes determining an available resource amount to be used for an experiment in a Kubernetes-based cluster through Equation 1 (R_{cpu,exp}=R_{cpu}−R_{cpu,others}) and Equation 2 (R_{memory,exp}=R_{memory}−R_{memory,others}); setting the resource range to be allocated to each pod to perform the experiment according to the determined available resource amount; and deriving the number of pods to simultaneously run using a resource quota to be allocated to each pod that is determined based on the set resource range. In Equation 1, R_{cpu,exp} denotes a central processing unit (CPU) available resource amount to be used for the experiment in the Kubernetes-based cluster, R_{cpu} denotes a CPU resource of the Kubernetes-based cluster, and R_{cpu,others} denotes a CPU resource currently allocated or in use other than the experiment, in Equation 2, R_{memory,exp} denotes a memory available resource amount to be used for the experiment in the Kubernetes-based cluster, R_{memory} denotes a memory resource of the Kubernetes-based cluster, and R_{memory}, others denotes a memory resource currently allocated or in use other than the experiment, and the setting of the resource range includes setting a maximum value and a minimum value of the resource range to be allocated to pods by measuring an amount of time used for a first pod in a first phase of an i^{th} experiment and (n−1) pods in a second phase of the i^{th} experiment, and the deriving includes determining importance of each experiment based on the resource range that is set according to the set maximum value and minimum value of the resource range to be allocated to the pods and determining a parallelism and the resource quota according to the determined importance of each experiment.

In Equation 1, R_{cpu,others} may be calculated according to Equation 3 (R_{cpu,others}=getK8sResourceQuota(t, cpu)+getK8sResource(t, cpu)+getSystemResource(t, cpu)), in Equation 2, R_{memory,others} may be calculated according to Equation 4 (R_{memory,others}=getK8sResourceQuota(t, memory)+getK8sResource(t, memory)+getSystemResource(t, memory)), in Equation 3 and Equation 4, getK8sResourceQuota ( ) may denote a function that derives resource information allocated to namespaces each in which a resource quota object is defined and may be calculated by summing resources allocated when generating the namespaces, in Equation 3 and Equation 4, getK8sResource ( ) may denote a function that derives resource information allocated to namespaces each in which a resource quota object is not defined and may be calculated based on a resource request amount, a resource limit amount, and an actual resource usage of pods present within the namespaces, and in Equation 3 and Equation 4, getSystemResource( ) may denote a sum of all resources used in a system other than the Kubernetes-based cluster.

The setting of the resource range may include measuring a maximum value of resources available for the i^{th} experiment in such a manner that the first pod performs the i^{th} experiment without resource limit in the first phase of the i^{th} experiment and measuring an amount of time used to measure the maximum value, and dividing the measured maximum value of resources into n sections where n denotes a natural number of 2 or more, running (n−1) pods for allocating each resource amount in parallel according to the divided n sections, and measuring an amount of time used to run the (n−1) pods in parallel, in the second phase of the i^{th} experiment.

The setting of the resource range may include calculating each resource amount ratio through the maximum value of resources corresponding to the divided sections over an amount of time used that is measured up to the second phase, setting a ratio threshold through the calculated each resource amount ratio and a 1/n ratio, and setting a minimum value of resources that do not fall below the set ratio threshold.

The deriving may include determining a value acquired by dividing a resource amount within the Kubernetes-based cluster available for the experiment by the number of experiment types as a resource quota of the i^{th} experiment, calculating a total amount of time and a total resource consumption to be used based on the determined resource quota of the i^{th} experiment and the number of experiment types, acquiring a score in time and a score in resources by acquiring reciprocal through scaling of each of the calculated total amount of time and total resource consumption based on the maximum value, acquiring a final score through a weighted sum by assigning a time weight and a resource weight to the acquired score in time and score in resources, respectively, and determining a resource quota to be allocated to each pod according to the acquired final score.

According to some example embodiments, it is possible to maximize the efficiency of hyperparameter optimization (HPO) by securing resources for performing hyperparameter optimization when performing multiple hyperparameter optimization in a Kubernetes environment, by distributing resources between the multiple hyperparameter optimization, and by allocating optimized resources to each pod within the secured resources and, at the same time, optimizing the number of experiment pods that are simultaneously running.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of a resource management system according to an example embodiment;

FIG. 2 is a flowchart illustrating a resource management method according to an example embodiment; and

FIG. 3 is a flowchart illustrating a detailed operation of resource management according to an example embodiment.

### DETAILED DESCRIPTION

Hereinafter, example embodiments will be described with reference to the accompanying drawings.

Katib refers to opensource software that generates/performs a plurality of experiment objects to search for optimized hyperparameter optimization (HPO) of a machine learning (ML) model in a Kubernetes environment. To perform the hyperparameter optimization (HPO), tens to hundreds of Kubernetes objects (experiment pods) need to be generated and a lot of resources (central processing unit (CPU), memory, etc.) are used. Also, to efficiently perform hyperparameter optimization (HPO), a resource amount to be allocated to each object and the number of objects to simultaneously run (parallelism) need to be determined. An example embodiment describes an operation that may secure resources for performing hyperparameter optimization (HPO) from an available resource amount of a Kubernetes-based cluster and may efficiently perform multiple hyperparameter optimization (HPO) within the secured resources.

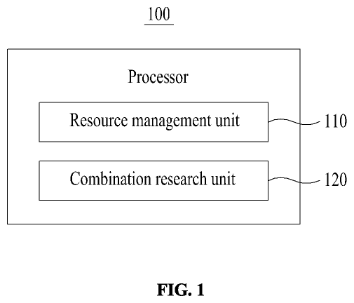

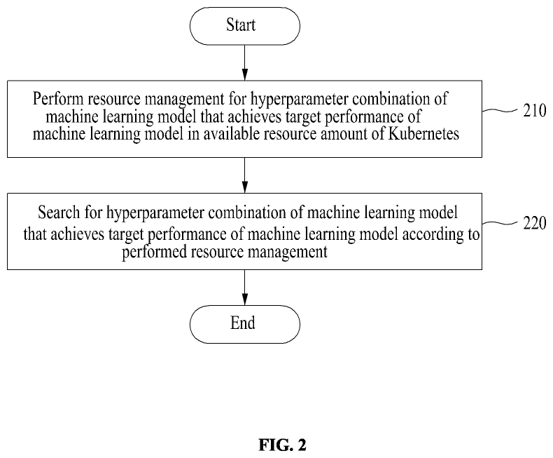

FIG. 1 is a block diagram illustrating a configuration of a resource management system according to an example embodiment, and FIG. 2 is a flowchart illustrating a resource management method according to an example embodiment.

A processor of a resource management system 100 may include a resource management unit 110 and a combination search unit 120. The components of the processor may be representations of different functions performed by the processor in response to a control instruction provided from a program code that is stored in the resource management system 100. The processor and the components of the processor may control the resource management system 100 that performs operations 210 and 220 included in the resource management method of FIG. 2. Here, the processor and the components of the processor may be implemented to execute an instruction according to a code of an operating system (OS) included in a memory and a code of at least one program.

The processor may load a program code stored in a file of a program for the resource management method to a memory. For example, when the program runs in the resource management system 100, the resource management system 100 may be controlled to load the program code from the file of the program under control of the OS. Here, the resource management unit 110 and the combination search unit 120 of the processor may be different functional representations of the processor for performing operations 210 and 220 by executing an instruction of a corresponding part in the program code loaded to the memory.

In operation 210, the resource management unit 110 may perform resource management for searching for a hyperparameter combination of a machine learning model that achieves a target performance of the machine learning model in an available resource amount of Kubernetes. The resource management unit 110 may determine an available resource amount to be used for an experiment in a Kubernetes-based cluster. The resource management unit 110 may set the resource range to be allocated to each pod to perform the experiment according to the determined available resource amount. The resource management unit 110 may derive the number of pods to simultaneously run using a resource quota to be allocated to each pod that is determined based on the set resource range.

In operation 220, the combination search unit 120 may search for the hyperparameter combination of the machine learning model that achieves the target performance of the machine learning model according to the performed resource management.

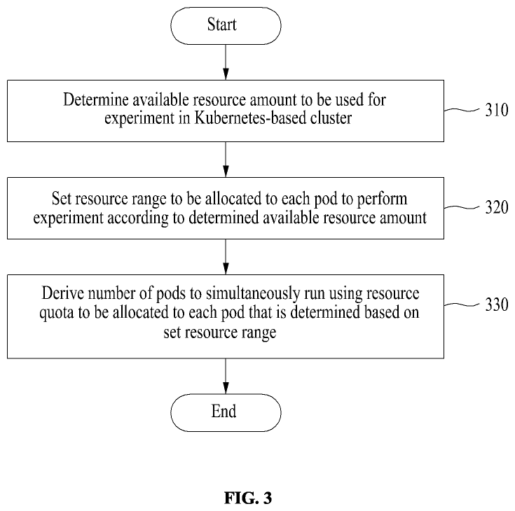

FIG. 3 is a flowchart illustrating a detailed operation of resource management according to an example embodiment.

A resource management system may perform resource management for hyperparameter optimization through three phases. A first phase is to determine a resource amount available for an experiment in the entire cluster, a second phase is to verify the range of a resource amount to be allocated to each experiment pod, and a third phase is to determine the number of pods to simultaneously run (parallelism) and to firmly determine a resource amount to be allocated to each pod.

In operation 310, the resource management system may determine an available resource amount to be used for an experiment in a Kubernetes-based cluster. Description is made using a central processing unit (CPU) and a memory as target resources and resources of the entire Kubernetes-based cluster are assumed to be R_{cpu} and R_{memory}. R_{cpu} denotes a CPU resource of the Kubernetes-based cluster, R_{memory} denotes a memory resource of the Kubernetes-based cluster. A resource to be allocated for the experiment among resources of the entire cluster may be acquired as follows.

$${R}_{cpu , exp} = {R}_{cpu} - {R}_{cpu , others} \qquad Equation 1$$

$${R}_{memory , exp} = {R}_{memory} - {R}_{memory , others} \qquad Equation 2$$

Here, R_{cpu,exp} denotes a CPU available resource amount to be used for the experiment in the Kubernetes-based cluster, and R_{memory,exp} denotes a memory available resource amount to be used for the experiment in the Kubernetes-based cluster.

R_{cpu} and R_{memory} may be calculated as a sum of a physical CPU core and a memory of host nodes that constitute the Kubernetes cluster.

R_{cpu,others} and R_{memory,others} denote a CPU resource currently allocated or in use other than the experiment and a memory resource currently allocated or in use other than the experiment, respectively, and may be determined through summation in units of namespaces and calculated as follows.

$${R}_{cpu , others} = get K 8 s ResourceQuota ( t , cpu ) + get K 8 s Resource ( t , cpu ) + getSystemResource ( t , cpu ) \qquad Equation 3$$

$${R}_{memory , others} = get K 8 s ResourceQuota ( t , memory ) + get K 8 s Resource ( t , memory ) + getSystemResource ( t , memory ) \qquad Equation 4$$

Here, (t, cpu) denotes a CPU resource used or allocated at a time t, and (t, memory) denotes a memory resource used or allocated at the time t. Also, getK8sResourceQuota ( ) denotes a function that derives resource information allocated to namespaces each in which a resource quota object is defined and may be calculated by summing resources allocated when generating the namespaces.

$$get K 8 s ResourceQuota ( t , resource ) = \sum ( namespace resource quote ) , \qquad Equation 5$$

where resource: cpu or memory
getK8sResource ( ) denotes a function that derives resources allocated to namespaces each in which a resource quota object is not defined and may be calculated based on a resource request, a limit, and an actual resource usage of pods present within a namespace. For example, it may be generated by entering a request amount and a limit amount in Kubernetes pod settings, “request” indicates that at least this amount of resources need to be allocated, “limit” indicates that this pod may use resources up to here (as much as possible), and “actual resource usage” indicates an amount of resources actually being used between “request” and “limit.”

The range of getK8sResource ( ) may be acquired by assigning a weight of each metric according to user settings, which affects a minimum value (g(t)min) and a maximum value (g(t)max) of g(t)(g_{cpu} (t) or g_{memory} (t)). Here, g(t) denotes a total sum of resources used or allocated other than an experiment and g_{cpu} (t) and g_{memory} (t) are implementations of g(t) in terms of a CPU and a memory, respectively.

$$get K 8 s ResourceQuota ( t , resource ) \sum min ( {w}_{i , limit} * {resource}_{i , limit} + {w}_{i , request} * {resource}_{i , request} + wi , usage * {resource}_{i , usage} , {resource}_{i , usage} , \qquad Equation 6$$

where resource: cpu or memory

Weights W_{i,limit}, W_{i,request}, and W_{i,usage} are determined according to user settings and a value is determined according thereto. Here, the determined value needs to be equal to or greater than a current usage of an i^{th} pod.

getSystemResource( ) denotes a sum of all resources used in a system other than Kubernetes.

$$getSystemResource ( t , resource ) = \sum ( other systems which is not related with K 8 s ) , where resource : cpu or memory \qquad Equation 7$$

The range of resource amount allocated or in use is determined according to user settings and Rₒₜₕₑᵣₛ(t) may have a minimum value (Rₒₜₕₑᵣₛ,min(t)) and a maximum value (R_{others,max} (t)) within the determined range of the resource amount.

Therefore, g(t) may be determined within the following range.

$${R}_{others , min} ( t ) ≦ {R}_{others} ( t ) ≦ {R}_{others , max} ( t ) \qquad Equation 8$$

In operation 320, the resource management system may set the resource range to be allocated to each pod to perform the experiment according to the determined available resource amount. When Kubernetes resources available for the experiment is verified, the resource management system may set the resource range required for running each pod to perform the experiment.

To verify the allocation resource range of each pod of an i^{th} experiment, a first pod in a first phase of the i^{th} experiment may perform the i^{th} experiment without resource limit and may measure a maximum value R_{exp-pod,max} of resources available for the corresponding experiment and may measure an amount of time t_{exp-pod,max} used to measure the maximum value of resources available for the corresponding experiment.

R_{exp-pod,max}, t_{exp-pod,max} where i-th experiments

In a second phase of the i^{th} experiment, the resource management system divides the maximum value R_{exp-pod,max} of resources acquired in the first phase into n (default=5) sections, runs (n−1) pods to which the respective resources are allocated in parallel, and measures an amount of time used to run the pods in parallel.

For example, if R_{exp-pod,max}=1000 mcpu, the resource management system divides the same into sections of 200/400/600/800/1000 mcpu, generates pods having four resource amounts (200/400/600/800 mcpu) aside from 1000 mcpu performed in a first experiment, and measures an amount of time.

A resource amount ratio is calculated through a maximum value of resources corresponding to the divided section over an amount of time used based on an amount of time used that is measured up to the second phase.

For example, the above example is calculated as in the following table.

| | | | | | |
|---|---|---|---|---|---|
| R (mcpu) | 200 | 400 | 600 | 800 | 1000 |
| t (msec) | 2000 | 1000 | 500 | 300 | 200 |
| Ratio (R/t) | 0.1 | 0.4 | 1.2 | 2.67 | 5 |

β(default=1/n) ratio of R_{exp-pod,max} ratio is determined as ratio_{threshold}, and a minimum resource amount (minimum value of resources) at which a resource amount ratio to an amount of time used does not fall below ratio_{threshold} is set as R_{exp-pod,min}.

In the above example, if ratio_{threshold}=1 (R_{exp-pod,max} ratio=5, β=⅕), R_{exp-pod,min} becomes 600 mcpu.

$$\begin{matrix}{R}_{exp - pod , min} = arg min ( list of R which divided by n space ) \\ where ratio >= {ratio}_{threshold} \\ ( {ratio}_{threshold} = {R}_{exp - pod , max} * β )\end{matrix} \qquad Equation 9$$

By measuring an amount of time used for the first pod in the first phase of the i^{th} experiment and (n−1) experiment pods in the second phase, the maximum value (R_{exp-pod, max}) and the minimum value (R_{exp-pod,min}) of the resource range to be allocated to the experiment pods are set.

In operation 330, the resource management system may derive the number of pods to simultaneously run using a resource quota to be allocated to each pod that is determined based on the set resource range.

When the resource amount (Rₑₓₚ) within the Kubernetes cluster available for the experiment and the resource range (R_{exp-pod,max}˜R_{exp-pod,min}) to be allocated to pods of each i^{th} experiment when k different experiments are performed are determined, importance (time, resource) of each experiment is determined and parallelism and the resource quota are determined.

The resource quota R_{exp,i} to be allocated for the i^{th} experiment may vary according to the importance of each experiment. Basically, a value acquired by dividing Rₑₓₚ by k is set as a basic quota. Although an experiment quota varies depending on the importance, the following method may be applied in the same manner. In addition, a total number of executions m (default=100) of a corresponding experiment may be specified by a user.

$${R}_{exp , i} = {R}_{exp} / k , \qquad Equation 10$$

where k is total #of experiments
m is user-setting value
(default=100)

Once available resources for the experiment (resource quota to be allocated to the i^{th} experiment) (R_{exp,i}) and the number of experiments to run (number of experiment types) (k) are determined, each of a total amount of time to be used (time_{exp,i}) and a total resource consumption (resources_{exp,i}) is calculated according to R_{exp-pod, max}˜R_{exp-pod,min}.

$$\begin{matrix}{time}_{exp , i , j} = CEILING ( m / FLOOR ( {R}_{exp , i} / {R}_{exp - pod , j} ) ) * {t}_{exp - pod , j} \\ {resources}_{exp , i , j} = m * {R}_{exp - pod , j}\end{matrix} , \qquad Equation 11$$

where j is candidate pod number which assigned resource between R_{exp-pod,max}˜R_{exp-pod,min}

Here, CEILING denotes rounding up a decimal point, FLOOR denotes rounding down a decimal point, and an expected amount of time used (time_{exp,I,j}) and an expected resource consumption (resources_{exp,i,j}) when selecting j candidates are acquired. When m experiments need to be performed, the number of experiments that may be simultaneously run with resources allocated to experiments (FLOOR (R_{exp,i}/R_{exp-pod,j})) may be acquired, the number of phases required (CEILING (m/FLOOR (R_{exp,i}/R_{exp-pod,j}))) may be acquired, and a total amount of time required may be acquired by multiplying the same by a run time. Resources resources_{exp,i,j} may be calculated by multiplying m by a corresponding candidate resource quota. j denotes a number of a candidate pod to which a resource between R_{exp-pod,max} and R_{exp-pod,min} is allocated.

For example, if Rₑₓₚ=50,000, number of experiment types to run k=10, and number of experiments to be repeated in each experiment m=100, they may be calculated as follows.

| | | | |
|---|---|---|---|
| R (mcpu) | 600 | 800 | 1000 |
| t (msec) | 500 | 300 | 200 |
| R_{exp,i} | 5,000 | 5,000 | 5,000 |
| m | 100 | 100 | 100 |
| # of exp. | 8 | 6 | 5 |
| # of phase | 13 | 17 | 20 |
| time_{exp,i,j} | 6,500 | 5,100 | 4,000 |
| resources_{exp,i,j} | 60,000 | 80,000 | 100,000 |

Score of each case (each experiment, each pod) is calculated by acquiring reciprocal through scaling of each of time_{exp,i} and resources_{exp,i} based on the maximum value and through a weighted sum by assigning a time weight (Wₜᵢₘₑ) and a resource weight (Wᵣₑₛ) to each.

$$\begin{matrix}{score}_{time , i , j} = 1 / ( {time}_{exp , i , j} / {time}_{exp , i , max} ) \\ {score}_{resources , i , j} = 1 / ( {resources}_{exp , i , j} / {resources}_{exp , i , max} ) \\ {score}_{i , j} = {score}_{time , i , j} * {w}_{time} + {score}_{resources , i , j} * {w}_{res} , \\ where {w}_{time} + {w}_{res} = 1.\end{matrix} \qquad Equation 12$$

When applied to an example, the following is provided.

| | | | |
|---|---|---|---|
| R (mcpu) | 600 | 800 | 1000 |
| t (msec) | 500 | 300 | 200 |
| score_{time,i,j} | 1.0 | 1.27 | 1.63 |
| score_{resources,i,j} | 1.67 | 1.25 | 1.00 |

A final score is acquired according to a weight and accordingly, a resource amount to be allocated to each pod is determined.

If Wₜᵢₘₑ=0.5 and Wᵣₑₛ=0.5 by setting a time and a resource to be equally important, the final score is as shown in the following table and a resource of 600 is allocated to a pod and a parallelism is 8. The parallelism is determined according to FLOOR (R_{exp,i}/R_{exp-pod,j}), and

FLOOR (5000/600)=FLOOR (8.333)=8.

| | | | |
|---|---|---|---|
| R (mcpu) | 600 | 800 | 1000 |
| t (msec) | 500 | 300 | 200 |
| # of exp. | 8 | 6 | 5 |
| score_{i,j} | 1.33 | 1.26 | 1.31 |

A score and a pod resource selected according to each setting are as follows.

Wₜᵢₘₑ=0.9, Wᵣₑₛ=0.1->parallelism 5

| | | | |
|---|---|---|---|
| R (mcpu) | 600 | 800 | 1000 |
| t (msec) | 500 | 300 | 200 |
| score_{i,j} | 1.07 | 1.27 | 1.66 |
| # of exp. | 8 | 6 | 5 |
| selection | | | v |

Wₜᵢₘₑ=0.1, Wᵣₑₛ=0.9->parallelism 8

| | | | |
|---|---|---|---|
| R (mcpu) | 600 | 800 | 1000 |
| t (msec) | 500 | 300 | 200 |
| # of exp. | 8 | 6 | 5 |
| score_{i,j} | 1.60 | 1.25 | 1.06 |
| selection | v | | |

The apparatuses described herein may be implemented using hardware components, software components, and/or a combination thereof. For example, apparatuses and components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions to implement various operations embodied by a computer. Also, the media may include, alone or in combination with the program instructions, data files, data structures, and the like. Program instructions stored in the media may be those specially designed and constructed for the example embodiments, or they may be well-known and available to those having skill in the computer software arts. Examples of non-transitory computer-readable media include magnetic media such as hard disks, floppy disks, and magnetic tapes; optical media such as CD ROM disks and DVDs; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A resource management method performed by a resource management system, the resource management method comprising:
performing resource management for searching for a hyperparameter combination of a machine learning model that achieves a target performance of the machine learning model in an available resource amount of Kubernetes; and
searching for the hyperparameter combination of the machine learning model that achieves the target performance of the machine learning model according to the performed resource management,
wherein the performing of the resource management comprises:
determining an available resource amount to be used for an experiment in a Kubernetes-based cluster through Equation 1 (R_{cpu,exp}=R_{cpu}−R_{cpu,others}) and Equation 2 (R_{memory,exp}=R_{memory}−R_{memory,others});
setting the resource range to be allocated to each pod to perform the experiment according to the determined available resource amount; and
deriving the number of pods to simultaneously run using a resource quota to be allocated to each pod that is determined based on the set resource range,
in Equation 1, R_{cpu,exp} denotes a central processing unit (CPU) available resource amount to be used for the experiment in the Kubernetes-based cluster, R_{cpu} denotes a CPU resource of the Kubernetes-based cluster, and R_{cpu,others} denotes a CPU resource currently allocated or in use other than the experiment,
in Equation 2, R_{memory,exp} denotes a memory available resource amount to be used for the experiment in the Kubernetes-based cluster, R_{memory} denotes a memory resource of the Kubernetes-based cluster, and R_{memory,others} denotes a memory resource currently allocated or in use other than the experiment,
the setting of the resource range comprises setting a maximum value and a minimum value of the resource range to be allocated to pods by measuring an amount of time used for a first pod in a first phase of an i^{th} experiment and (n−1) pods in a second phase of the i^{th} experiment, and
the deriving comprises determining importance of each experiment based on the resource range that is set according to the set maximum value and minimum value of the resource range to be allocated to the pods and determining a parallelism and the resource quota according to the determined importance of each experiment.

2. The resource management method of claim 1, wherein:
$$\begin{matrix}in Equation 1 , {R}_{cpu , others} is calculated according to Equation 3 ( {R}_{cpu , others} = get K 8 s ResourceQuota ( t , cpu ) + get K 8 s Resources ( t , cpu ) + getSystemResource ( t , cpu ) , ) \\ in Equation 2 , {R}_{memory , others} is calculated according to Equation 4 ( {R}_{memory , others} = get K 8 s ResourceQuota ( t , memory ) + get K 8 s Resource ( t , memory ) + getSystemResource ( t , memory ) ) ,\end{matrix}$$
in Equation 3 and Equation 4, getK8sResourceQuota( ) denotes a function that derives resource information allocated to namespaces each in which a resource quota object is defined and is calculated by summing resources allocated when generating the namespaces,
in Equation 3 and Equation 4, getK8sResource( ) denotes a function that derives resource information allocated to namespaces each in which a resource quota object is not defined and is calculated based on a resource request amount, a resource limit amount, and an actual resource usage of pods present within a namespace, and
in Equation 3 and Equation 4, getSystemResource( ) denotes a sum of all resources used in a system other than the Kubernetes-based cluster.

3. The resource management method of claim 1, wherein the setting of the resource range comprises:
measuring a maximum value of resources available for the i^{th} experiment in such a manner that the first pod performs the i^{th} experiment without resource limit in the first phase of the i^{th} experiment and measuring an amount of time used to measure the maximum value, and
dividing the measured maximum value of resources into n sections where n denotes a natural number of 2 or more, running (n−1) pods for allocating each resource amount in parallel according to the divided n sections, and measuring an amount of time used to run the (n−1) pods in parallel, in the second phase of the i^{th} experiment.

4. The resource management method of claim 3, wherein the setting of the resource range comprises calculating each resource amount ratio through the maximum value of resources corresponding to the divided sections over an amount of time used that is measured up to the second phase, setting a ratio threshold through the calculated each resource amount ratio and a 1/n ratio, and setting a minimum value of resources that do not fall below the set ratio threshold.

5. The resource management method of claim 1, wherein the deriving comprises determining a value acquired by dividing a resource amount within the Kubernetes-based cluster available for the experiment by the number of experiment types as a resource quota of the i^{th} experiment, calculating a total amount of time and a total resource consumption to be used based on the determined resource quota of the i^{th} experiment and the number of experiment types, acquiring a score in time and a score in resources by acquiring reciprocal through scaling of each of the calculated total amount of time and total resource consumption based on the maximum value, acquiring a final score through a weighted sum by assigning a time weight and a resource weight to the acquired score in time and score in resources, respectively, and determining a resource quota to be allocated to each pod according to the acquired final score.
